(19) United States
(12) Patent Application Publication
(10) Pub. No.: US 2023/0151683 A1
(43) Pub. Date: May 18, 2023

(54) LADDER TAPE ASSEMBLY AND WINDOW BLIND USING THE LADDER TAPE ASSEMBLY

(71) Applicant: CHING FENG HOME FASHIONS CO., LTD., Fuxing Township (TW)

(72) Inventor: Ming-Chu CHIANG, Fuxing Township (TW)

(73) Assignee: CHING FENG HOME FASHIONS CO., LTD., Fuxing Township (TW)

(21) Appl. No.: 17/582,573

(22) Filed: Jan. 24, 2022

(30) Foreign Application Priority Data
Nov. 17, 2021 (TW) 110142834

(51) Int. Cl. E06B 9/303; D04B 21/10; E06B 9/382

(52) U.S. Cl. CPC E06B 9/303; D04B 21/10; E06B 9/382; D10B 2403/0311; D10B 2503/03

(57) ABSTRACT

A window blind includes a headrail, a blind body, two ladder tape assemblies and a bottom rail. By the technical features that the lift cords of the ladder tape assemblies are set in the mesh webbings, any one of the slats is surrounded by the supporting cords of the ladder tape assemblies arranged opposite to each other, and the two ends of the supporting cords are respectively braided and connected to the mesh webbings of the two ladder tape assemblies arranged opposite to each other, in addition to the effect of stabilizing the support between any of the slats, it can also reduce the possibility of the lift cords of the ladder tape assemblies being pulled out, thereby effectively preventing children from being accidentally entangled by the lift cords.

### BACKGROUND OF THE INVENTION

### 1. Field of the Invention

The present invention relates to window blind cord technology and more particularly, to a ladder tape assembly and window blind using the wide-version ladder tape assembly.

### 2. Description of the Related Art

At present, the common window blinds (e.g. venetian blinds) mostly use lift cords to make the blinds rise and fall or open and close. However, some children sometimes play under the window blind, and unpreventable accidents can happen if the guardian or caregiver is careless. For example, there are some accidents caused by window blind lift cords in foreign countries, or because the child's curiosity is driven to play with the lift cord, his hands, feet, and neck are accidentally entangled by the lift cord, which causes avascular necrosis of the limbs, and even cannot break free and suffocation. Therefore, the current common window blinds do have security problems.

### SUMMARY OF THE INVENTION

The present invention has been accomplished under the circumstances in view. In order to solve the problems mentioned in the previous technology, the present invention to provide a window blind (for example, venetian blind), which comprises at least two ladder tape assemblies to improve the dangerous phenomenon of effectively preventing people or children from being accidentally entangled by lift cord when the window blind is folded or extended.

The window blind disclosed in the present invention comprises a headrail, a blind body, at least two ladder tape assemblies, and a bottom rail. The blind body is composed of a plurality of elongated slats. One side of one slat is set close to the headrail, and one side of another slat is set on the bottom rail. The two opposite long sides of the long axis of each slat are individually recessed to form at least one limit portion. Each ladder tape assembly comprises two wide webbings, a mesh webbing, a lift cord and multiple supporting cords. The mesh webbing is fixedly connected to the two long sides of wide webbings so that the mesh webbing is located between the two wide webbings. The lift cord is set in the mesh webbing. One end of any supporting cord is individually connected and fixed at the position of the mesh webbing. One ends of the lift cords of the two ladder tape assemblies are respectively inserted through a plurality of tape insertion holes of the headrail and then tied to a tape reel set in the headrail so that the two ladder tape assemblies are electrically controlled by the tape reel to produce rolling and flipping movements. The other ends of the lift cords of the two ladder tape assemblies extend in the direction of the bottom rail along the two opposite long sides of the slats of the blind body and are wrapped around the bottom rail and tied and fixed. The two ladder tape assemblies are arranged oppositely based on the two long sides of the slats of the blind body, and any one of the ladder tape assemblies is limited to the at least one limit portion of the same long side of the slats of the blind body.

In summary, by the technical features that the lift cords of the ladder tape assemblies are set in the mesh webbings, any one of the slats is surrounded by the supporting cords of the ladder tape assemblies arranged opposite to each other, and the two ends of the supporting cords are respectively braided and connected to the mesh webbings of the two ladder tape assemblies arranged opposite to each other, in addition to the effect of stabilizing the support between any of the slats, it can also reduce the possibility of the lift cords of the ladder tape assemblies being pulled out, thereby effectively preventing children from being accidentally entangled by the lift cords.

### BRIEF DESCRIPTION OF THE DRAWINGS

FIG. 1 is an oblique top elevational view of a preferred embodiment of the present invention, which mainly reveals a state in which a window blind is unfolded.

FIG. 2 is an enlarged schematic diagram of part of the components of FIG. 1, which mainly reveals the positional correspondence between the two ladder tape assemblies on one side of the window blind and one of the slats.

FIG. 3 is a schematic side view of FIG. 1, which mainly reveals the connection relationship between the two ladder tape assemblies of the window blind and the slats.

FIG. 4 is an enlarged schematic diagram of part of the components of FIG. 1, which mainly reveals one of the ladder tape assembly of the window blind.

FIG. 5 is an enlarged and side view schematic diagram of some components similar to FIG. 4.

FIG. 6 is an enlarged schematic diagram of part of the components of FIG. 1, which mainly reveals the connection relationship between the two ladder tape assemblies on one side of the window blind and the bottom rail.

### DETAILED DESCRIPTION OF THE INVENTION

The applicant first states here that throughout the specification, including the preferred embodiment described below and the claims in the scope of patent application, the terms related to directionality are based on the directions in the drawings. The applicant first explains here that in the entire specification, including the embodiment described below and the various claims in the scope of the patent application, the nouns related to directionality are based on the directions of the diagrams listed in the BRIEF DESCRIPTION OF THE DRAWINGS of the present application. Secondly, in the preferred embodiment and drawings to be described below, the same element numbers represent the same or similar elements or their structural features. Moreover, the detailed structure, characteristics, assembly or use, manufacturing and other methods of the present invention will be described in the detailed description of the subsequent embodiments. However, those with ordinary knowledge in the field of the present invention should be able to understand that these detailed descriptions and the examples listed in the present invention are only used to support the explanation that the present invention can actually be implemented, and are not intended to limit the patent scope of the present invention.

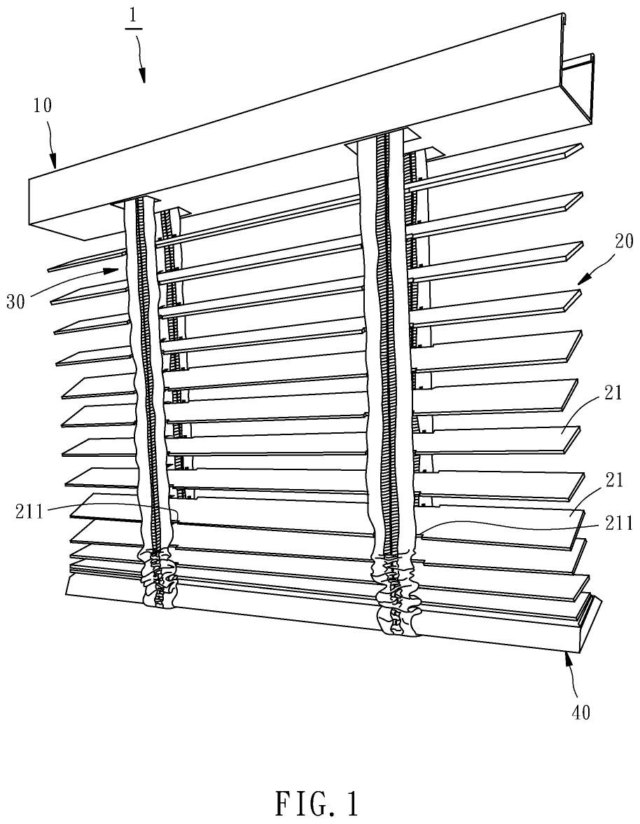

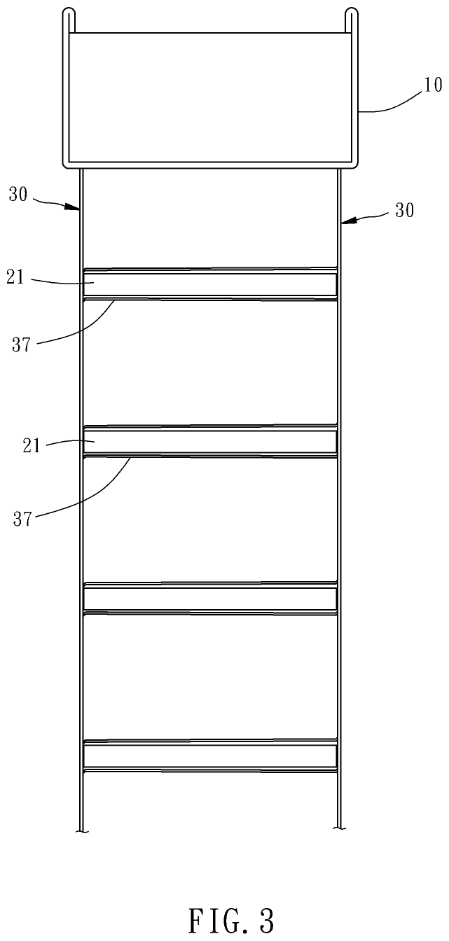

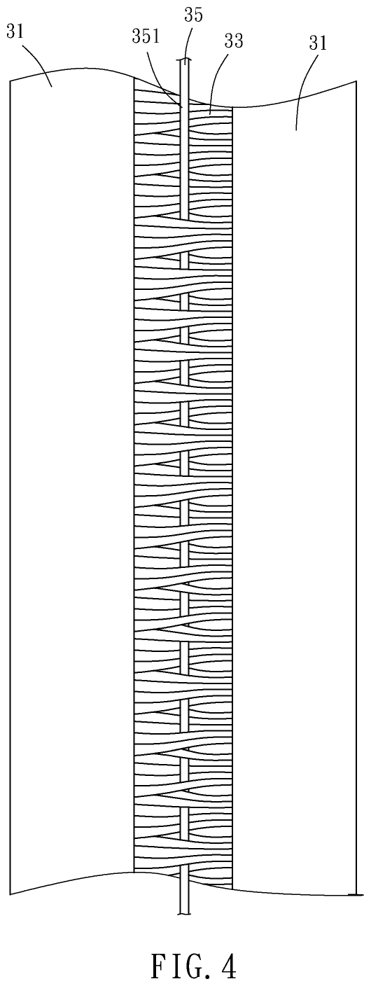

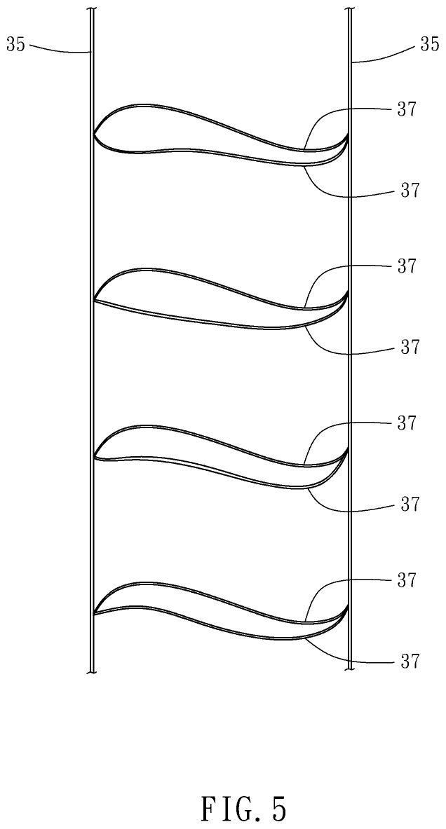

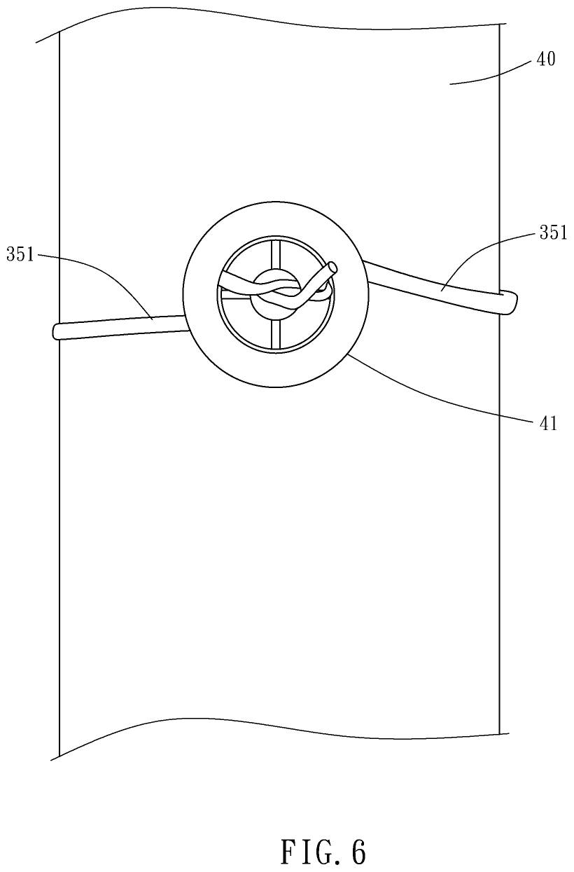

Referring to FIGS. 1-6, a window blind 1 (for example, venetian blind) provided by the preferred embodiment of the present invention comprises a headrail 10, a blind body 20, four ladder tape assemblies 30, and a bottom rail 40.

The blind body 20 is a blind body composed of a plurality of elongated slats 21, which is commonly known as a venetian blind. One side of one of the slats 21 of the blind body 20 is set close to the headrail 10, and tone side of another one of the slats 21 of the blind body 20 is set on the bottom rail 40. Each of two opposite long sides of the long axis of each slat 21 is recessed to form two limit portions 211 at intervals. Preferably, the limit portions 211 of any one of the slats 21 are arranged opposite to each other along the long axis of the slat 21. It is worth mentioning that, depending on the actual length of the blind body 20, at least one limit portion 211 can be selectively recessed on the two opposite long sides of the long axis of each slat 21. This quantity is attributable to the optional needs of users and designers, and will not be repeated here.

The ladder tape assemblies 30 defined on the two opposite long sides of the long axis of the plural slats 21 of the blind body 20 are grouped in pairs, and one end of each ladder tape assembly 30 is tied to a tape reel provided in the headrail 10 (this is a conventional technical feature, and it is not mostly inked here), and it can be electrically controlled by the tape reel to produce movement such as rolling and turning. Each ladder tape assembly 30 is composed of two wide webbings 31, a mesh webbing 33, a lift cord 35 and a plurality of supporting cords 37. The mesh webbing 33 is connected and fixed with the two relatively long sides of the two wide webbings 31 by knitting, weaving, or weaving, etc., so that the mesh webbing 33 is between the two wide webbings 31. The lift cord 35 is sheathed in the mesh webbing 33, so that the lift cord 35 is similarly between the two wide webbings 31, and the two end reserved sections 351 of the lift cord 35 are respectively exposed to the mesh webbing 33. In this way, one end of each ladder tape assembly 30 is tied to the tape reel provided in the headrail 10 by the exposed end of the lift cord 35, the other ends of any two ladder tape assemblies 30 pass through the plurality of tape insertion holes 11 of the headrail 10, and then follow the two opposite long sides of the plurality of slats 21 of the blind body 20 and extend toward the direction of the bottom rail 40. Until any two of the ladder tape assemblies 30 are individually wrapped around the bottom rail 40 with the exposed other end of the lift cord 35, they are then tied to two rope fasteners 41 provided at the bottom of the bottom rail 40. In addition, since the ladder tape assemblies 30 are arranged in pairs based on the two relatively long sides of the plural slats 21 of the blind body 20, any one of the slats 21 is surrounded by the supporting cords 37 of the ladder tape assemblies 30 arranged opposite to each other, and the two ends of the supporting cords 37 are respectively braided and connected to the mesh webbings 33 of the two ladder tape assemblies 30 arranged opposite to each other. Preferably, the two ends of the supporting cords 37 are respectively braided and fixed to the mesh webbings 33 of the two oppositely arranged ladder tape assemblies 30, and are respectively tied and fixed to the lift cords 35 of the two oppositely arranged ladder tape assemblies 30. Furthermore, because the two relatively long sides of the plural slats 21 of the blind body 20 are all recessed to form the respective two limit portions 211, and the imaginary center points of the two limit portions 211 on the same long side of each slat 21 correspond to the positions of the tape insertion holes 11 of the headrail 10 and the positions of the two rope fasteners 41 of the bottom rail 40 respectively, any one of the ladder tape assemblies 30 is limited to the limit portions 211 on the same long side of the plural slats 21 of the blind body 20. The overall width of any of the ladder tape assemblies 30 is less than or equal to the inner diameter of the limit portions 211 of any of the slats 21.

The above are the technical features of the window blind 1 (for example, venetian blind) and its components disclosed in the preferred embodiment of the present invention. Next, we will continue to disclose how the ladder tape assemblies 30 installed on the two opposite long sides of the blind body 20 of the window blind 1 cooperate with the operation of the overall window blind 1, thereby effectively improving the problem of the prior art disclosure and achieving the expected effect of the present invention:

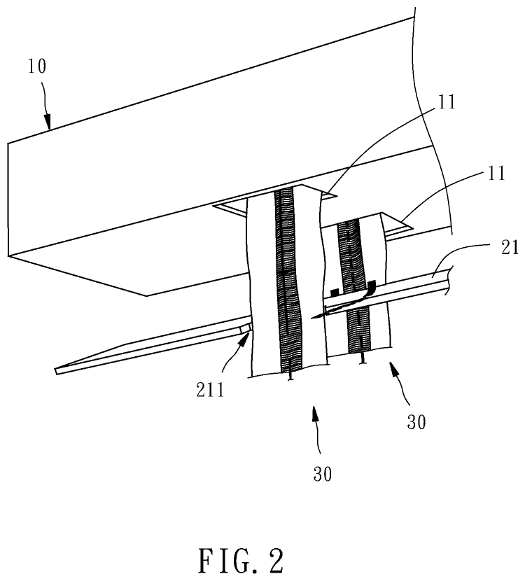

One, please refer to FIG. 1 and FIG. 2 together, by the technical features of defining the ladder tape assemblies 30 arranged on the two opposite long sides of the long axis of the plural slats 21 of the blind body 20 as a pair of two, and letting one end of each ladder tape assembly 30 be tied to the tape reel set in the headrail 10, the ladder tape assemblies 30 can be electrically controlled by the tape reel of the headrail 10 to produce almost synchronized scrolling and flipping motions (e.g., opening, closing, etc.).

Second, please refer to FIGS. 1-5 together, by the technical features that the lift cords 35 of the ladder tape assemblies 30 are set in the mesh webbings 33, any one of the slats 21 is surrounded by the supporting cords 37 of the ladder tape assemblies 30 arranged opposite to each other, and the two ends of the supporting cords 37 are respectively braided and connected to the mesh webbings 33 of the two ladder tape assemblies 30 arranged opposite to each other, in addition to the effect of stabilizing the support between any of the slats 21, it can also reduce the possibility of the lift cords 35 of the ladder tape assemblies 30 being pulled out, thereby effectively preventing children from being accidentally entangled by the lift cords.

Third, please refer to FIGS. 1-4 together, by allowing any of the ladder tape assemblies 30 to be limited in the limit portions 211 on the same long side of the plural slats 21 of the blind body 20, in addition to allowing the window blind 1 to achieve a consistent aesthetic effect, any ladder tape assembly 30 can be indirectly controlled by the electrical control of the tape reel of the headrail 10 to produce nearly synchronized scrolling and flipping motions, thereby achieving a more stable scrolling or flipping effect.

Fourth, please refer to FIGS. 1, 2 and 4 together, by the technical feature that the overall width of any one of the ladder tape assemblies 30 is less than or equal to the inner diameter of the limit portions 211 of any one of the slats 21 of the blind body 20, the window blind 1 achieves a very strong effect through the wide appearance of the ladder tape assemblies 30.

What is claimed is:

1. A ladder tape assembly (30), comprising two wide webbings (31), a mesh webbing (33), a lift cord (35) and a plurality of supporting cords (37), said mesh webbing (33) and two relatively long sides of said two wide webbings (31) being connected and fixed so that said mesh webbing (33) is between said two wide webbings (31), said lift cord (35) being set in said mesh webbing (33), one end of each said supporting cord (37) being individually connected and fixed at the position of said mesh webbing (33).

2. The ladder tape assembly (30) as claimed in claim 1, wherein one end of each said supporting cord (37) is separately connected and fixed at the position of said mesh webbing (33) and said lift cord (35).

3. The ladder tape assembly (30) as claimed in claim 2, wherein the two ends of said lift cord (35) each have an end reserved section (351), so that the two said end reserved sections (351) are each exposed to said mesh webbing (33).

4. A window bling (1), comprising: a headrail (10), a blind body (20), at least two ladder tape assemblies (30) as described in claim 3, and a bottom rail (40), said blind body (20) being composed of a plurality of elongated slats (21), one side of one said slat (21) being set close to said headrail (10), and one side of another said slat (21) being set on said bottom rail (40), wherein: two opposite long sides of the long axis of each said slat (21) are individually recessed to form at least one limit portion (211); one ends of the said lift cords (35) of said two ladder tape assemblies (30) are respectively inserted through a plurality of tape insertion holes (11) of said headrail (10) and then tied to a tape reel set in said headrail (10) so that the said two ladder tape assemblies (30) are electrically controlled by said tape reel to produce rolling and flipping movements, and the other ends of the said lift cords (35) of said two ladder tape assemblies (30) extend in the direction of said bottom rail (40) along the two opposite long sides of said slats (21) of said blind body (20) and are wrapped around said bottom rail (40) and tied and fixed; said two ladder tape assemblies (30) are arranged oppositely based on the two long sides of said slats (21) of said blind body (20), and any one of said ladder tape assemblies (30) is limited to the said at least one limit portion (211) of the same long side of said slats (21) of said blind body (20).

5. The window bling (1) as claimed in claim 4, wherein each said slat (21) of said blind body (20) is surrounded by the said supporting cords (37) of said two ladder tape assemblies (30) that are arranged opposite each other, and the two ends of the said supporting cords (37) are respectively connected and fixed at the said mesh webbings (33) of the said two ladder tape assemblies (30).

6. The window bling (1) as claimed in claim 5, wherein the two ends of the said supporting cords (37) of said ladder tape assemblies (30) are respectively connected and fixed at the said lift cords (35) of the said two ladder tape assemblies (30).

7. The window bling (1) as claimed in claim 6, wherein said bottom rail (40) is provided with at least one rope fastener (41), and the imaginary center point of the said at least one limit portion (211) of the same long side of each said slat (21) of said blind body (20) corresponds to the location of said at least one rope fastener (41) of said bottom rail (40).

8. The window bling (1) as claimed in claim 4, wherein the two ends of the said supporting cords (37) of said ladder tape assemblies (30) are respectively connected and fixed at the said lift cords (35) of said two ladder tape assemblies (30).

9. The window bling (1) as claimed in claim 8, wherein said bottom rail (40) is provided with at least one rope fastener (41), and the imaginary center point of the said at least one limit portion (211) of the same long side of each said slat (21) of said blind body (20) corresponds to the location of said at least one rope fastener (41) of said bottom rail (40).

10. The window bling (1) as claimed in claim 4, wherein the overall width of any of said ladder tape assemblies (30) is less than or equal to the inner diameter of the said at least one limit portion (211) of each said slat (21) of said blind body (20).

11. The window bling (1) as claimed in claim 5, wherein the overall width of any of said ladder tape assemblies (30) is less than or equal to the inner diameter of the said at least one limit portion (211) of each said slat (21) of said blind body (20).

12. The window bling (1) as claimed in claim 6, wherein the overall width of any of said ladder tape assemblies (30) is less than or equal to the inner diameter of the said at least one limit portion (211) of each said slat (21) of said blind body (20).

13. The window bling (1) as claimed in claim 7, wherein the overall width of any of said ladder tape assemblies (30) is less than or equal to the inner diameter of the said at least one limit portion (211) of each said slat (21) of said blind body (20).

14. The window bling (1) as claimed in claim 8, wherein the overall width of any of said ladder tape assemblies (30) is less than or equal to the inner diameter of the said at least one limit portion (211) of each said slat (21) of said blind body (20).

15. The window bling (1) as claimed in claim 9, wherein the overall width of any of said ladder tape assemblies (30) is less than or equal to the inner diameter of the said at least one limit portion (211) of each said slat (21) of said blind body (20).
